(19) United States
(12) Patent Application Publication
(10) Pub. No.: US 2026/0268764 A1
(43) Pub. Date: Sep. 10, 2026

(54) DETECTION AND RECONSTRUCTION OF ROAD INCIDENTS

(71) Applicant: NOTRAFFIC LTD, Tel-Aviv (IL)

(72) Inventors: Or SELA, Tel-Aviv (IL); Uriel KATZ, Ramat Gan (IL); Christopher BLATCHLY, West Newbury, MA (US)

(21) Appl. No.: 19/164,897

(22) PCT Filed: Mar. 20, 2024
(86) PCT No.: PCT/IL2024/050288

§ 371 Date: Sep. 12, 2025

Related U.S. Application Data
(60) Provisional application No. 63/491,217, filed on Mar. 20, 2023.

(51) Int. Cl. G08G 1/01; G06N 20/20

(52) U.S. Cl. CPC G08G 1/0133; G06N 20/20; G08G 1/0108

(57) ABSTRACT

Some embodiments relate to a method and system of incident detection and reconstruction using road-informative data collected by a plurality of source-modalities. The method includes separately for each given source-modality (SM) from the plurality of source-modalities, processing road-informative data collected by the given SM to obtain one or more feature-level data-modalities associated with the given SM, thereby giving rise to a plurality of obtained data-modalities, wherein each given data-modality is informative of one or more features extracted, during processing, from road-informative data collected by an associated SM. When at least one data-modality from the plurality of data-modalities is indicative of a potential incident, fusing the plurality of data-modalities into one or more machine learning models (MLMs) to confirm detecting the incident; and responsive to the confirmation of the incident detection, providing incident reconstruction and/or other incident-related actions.

### CROSS-REFERENCES TO RELATED APPLICATIONS

The present application is a national phase filing under 35 C.F.R. § 371 of and claims priority to PCT Patent Application No. PCT/IL2024/050288, filed on Mar. 20, 2024, which claims benefit from U.S. Provisional Application No. 63/491,217 filed on Mar. 20, 2023, and incorporated hereby by reference in its entirety.

### TECHNICAL FIELD

The presently disclosed subject matter relates to techniques of traffic management and, more particularly, to methods and systems for automated detection and reconstruction of road incidents.

### BACKGROUND

Automated detection and reconstruction of road incidents are crucial components of modern traffic management systems. By promptly detecting incidents, traffic management systems can reroute traffic and implement alternative strategies to minimize congestion and maintain smoother traffic flow. Automated incident reconstruction assists investigators and authorities in understanding the sequence of events, determining fault, and improving the accuracy of post-incident analysis.

Likewise, automated detection and reconstruction help in optimization of allocating emergency services and law enforcement resources. Furthermore, collected incident data can be analyzed to identify patterns and potential causes, aiding in the development of preventive measures and infrastructure improvements to reduce the likelihood of future incidents.

Thus, automated detection and reconstruction of incidents can contribute to enhanced safety, rapid response, efficient resource allocation, and improved post-incident analysis and prevention strategies.

It is noted that the terms “road incident” or “incident” used herein are referred to an event that affects traffic and disrupts normal traffic flow or poses a potential hazard. The terms “road accident” or “accident” are referred to herein to harmful incidents involving vehicles colliding with each other or with other objects. Accidents can range from minor collisions to more severe events involving injuries or fatalities. Accidents can result in significant loss of life, property damage, and traffic disruptions, making them a major concern for city officials, transportation planners, insurance companies, and other stakeholders.

Problems of automated incidents detection and reconstruction have been recognized in the conventional art and various techniques have been developed to provide solutions, for example:

U.S. Pat. No. 9,773,281 discloses a technique of accident detection and recovery. One or more devices in an accident detection and recovery computing system may be configured to determine that vehicle accidents have occurred, collect and analyze accident characteristics and other related data, and provide customized accident recovery services. Mobile computing devices, alone or in combination with vehicle-based systems and external devices, may detect accidents or receive accident indication data. After determining that an accident has occurred, mobile computing devices and/or vehicle-based systems may be configured to determine accident characteristics, retrieve vehicle data and vehicle occupant data from one or external servers, determine the damages or potential damages resulting from the accident, and determine one or more accident recovery options or recommendations based on the accident damages. Various user interface screens may be generated and displayed via the user's mobile device and/or a vehicle-based display device to provide the user with accident information, damages, and recovery options or recommendations.

U.S. Pat. No. 11,068,995 discloses a technique of reconstructing an accident scene using telematic data. The method comprises: receiving, from a vehicle occupied by a user, data indicating that the vehicle is involved in an accident; transmitting, in response to receiving the data, a communication to a mobile device of the user; displaying, via a mobile device application installed on the mobile device, the communication, wherein the communication prompts the user to provide responses to one or more questions regarding the accident; determining, based on the received data, a likely severity of the accident, wherein determining the likely severity includes determining whether one or more injuries were likely sustained during the accident; receiving an indication of a response to the one or more questions from the user; based on the determination of the likely severity of the accident and the received indication of the response to the one or more questions, prompting the user with an emergency assistance recommendation; and based on the determination of the likely severity of the accident, performing one or more assessments, wherein performing the one or more assessments includes at least one of determining damage to the vehicle, determining repairs needed for the vehicle, or determining fault of the user for the accident.

U.S. Pat. No. 11,620,862 discloses a technique for reconstructing information about vehicular accidents. The system comprises an onboard computing system in a vehicle with an accident reconstruction system. Using sensed information from vehicle sensors and an animation engine, the system can generate animated videos depicting the accident. The system can also take action in response to information it learns from the animated video and/or an underlying 3D model of the accident used to generate the video.

U.S. Pat. No. 11,682,289 discloses a technique for integrated traffic incident detection and response. The method comprises: an electronic device receives operational data indicative of an operational characteristic of a vehicle from a sensor of the electronic device, a sensor of the vehicle, and/or images/videos captured by a camera. The electronic device determines that the vehicle has had a potential incident and a likelihood that the potential incident has actually occurred based on analysis of the operational data. The electronic device also receives risk management data associated with the vehicle from a database, and determines a severity level for the potential incident based on the operational data and the risk management data. The electronic device then sends a notification indicative of the potential incident based on the likelihood that the potential incident has actually occurred and the severity level for the potential incident to a third-party remote system (e.g., of a towing service, an emergency service, or both) to request assistance.

US Patent Publication No. 2023/0074620 discloses a technique of automated incident detection for vehicles. The computer-implemented method comprises: receiving first data from a sensor of a vehicle; determining, by a processing device, whether an incident external to the vehicle has occurred by processing the first data using a machine learning model; responsive to determining that an incident external to the vehicle has occurred, initiating recording of second data by the sensor; and responsive to determining that an incident external to the vehicle has occurred, taking an action to control the vehicle.

US Patent Publication No. 2023/0367006 discloses a technique for incident detection using radar sensory data. A vehicular tracking system comprises at least one on-vehicle sensor, such as a radar sensor, that can perceive the environment around the vehicle and capture data related to possible incidents that may be viewed by the sensor. A radar sensor may provide radar data that can be used to calculate velocity vectors, accelerations vectors, azimuth and elevation angles of other vehicles, and this data may be collected and stored for possible incident characterization and accident investigation. The vehicle with the sensor may be configured to behave as a third-party witness to possible incidents. Several sensors may be used in conjunction with one another, where one sensor may trigger another sensor to begin capturing other data that the first sensor may be unable to capture.

The references cited above teach background information that may be applicable to the presently disclosed subject matter. Therefore, the full contents of these publications are incorporated by reference herein where appropriate for appropriate teachings of additional or alternative details, features and/or technical background.

### GENERAL DESCRIPTION

In accordance with certain aspects of the presently disclosed subject matter, there is provided a computerized method of incident detection using road-informative data collected by a plurality of source-modalities. The method comprises: separately for each given source-modality (SM) from the plurality of source-modalities, processing road-informative data collected by the given SM to obtain one or more feature-level data-modalities associated with the given SM, thereby giving rise to a plurality of obtained data-modalities, wherein each given data-modality is informative of one or more features extracted, during processing, from road-informative data collected by an associated SM. When at least one data-modality from the plurality of data-modalities is indicative of a potential incident, fusing the plurality of data-modalities into one or more machine learning models (MLMs) to confirm detecting an incident; and responsive to the confirmation of the incident detection, providing one or more incident-related actions.

In accordance with further aspects and, optionally, in combination with other aspects of the presently disclosed subject matter, the plurality of SMs can comprise a combination of at least one sensor configured to capture road-informative data with at least one of: a control unit configured to gather data from one or more road infrastructure elements, a V2X unit configured to receive vehicle motion-related and/or safety-related data; a cloud-based information module configured to collect behavioral and aggregated data related to the road.

In accordance with further aspects and, optionally, in combination with other aspects of the presently disclosed subject matter, processing road-informative data collected by the given SM can be provided to obtain a data-modality indicative of a potential incident. Optionally, one or more incident detection models used during the processing can depend on SM that has collected the respective road-informative data. Processing the road-informative data can comprise applying one or more anomaly detection models configured to detect a potential incident based on identifying unusual data patterns causable by said incident.

In accordance with further aspects and, optionally, in combination with other aspects of the presently disclosed subject matter, at least one data-modality can be informative of a predefined set of features corresponding to an associated SM and a type of incident effect, wherein the type of incident effect is selected from a group comprising direct effects, short-range indirect effects, medium-range indirect effects and long-range indirect effects.

In accordance with further aspects and, optionally, in combination with other aspects of the presently disclosed subject matter, the obtained data-modalities can be fusing into the one or more MLMs with assigned fusing weights. Optionally, a fusing weight of a given data-modality can depend on respectively associated SM and/or on one or more techniques applied to obtain the given data-modality.

In accordance with further aspects and, optionally, in combination with other aspects of the presently disclosed subject matter, the method can further comprise: for each given SM from at least part of the plurality of SMs, processing road-informative data collected by the given SM to obtain a first data-modality and a second data-modality associated therewith, thereby giving rise to a plurality of first data-modalities and a plurality of second data-modalities; fusing the plurality of first data-modalities into a first MLM to detect a potential incident with a first level of confidence; and further fusing the output of the first MLM and the plurality of second data-modalities into a second MLM to detect the potential incident with an enhanced level of confidence. Optionally, the first data-modalities can be informative of a predefined set of features corresponding to one or more direct incident effects and the second data-modalities can be informative of a predefined set of features corresponding to one or more short-range indirect incident effects.

The method can further comprise: for each given SM from at least part of the plurality of SMs, processing road-informative data collected by the given SM to obtain a third data-modality and a forth data-modality associated therewith, thereby giving rise to a plurality of third data-modalities and a plurality of forth data-modalities, wherein the third data-modalities are informative of a predefined set of features corresponding to one or more medium-term indirect incident effects and the fourth data-modalities are informative of a predefined set of features corresponding to one or more long-range indirect incident effects; fusing the output of the second MLM and the plurality of third data-modalities into a third MLM to detect the potential incident with further enhanced level of confidence; and further fusing the output of the third MLM and the plurality of fourth data-modalities into a fourth MLM to confirm detection of the incident.

In accordance with further aspects and, optionally, in combination with other aspects of the presently disclosed subject matter, the incident-related actions can include incident reconstruction and/or initiating respective alerts and/or reports.

In accordance with other aspects and, optionally, in combination with the above aspects of the presently disclosed subject matter, incident reconstruction comprises: collecting from the plurality of SMs incident-informative data corresponding to a timeframe around the point-in-time when the incident has occurred; processing the collected incident-informative data to generate the incident reconstruction model; using the generated incident reconstruction model to generate a visual representation of the incident; enriching the incident representation; and enabling rendering the reconstructed incident.

In accordance with further aspects and, optionally, in combination with other aspects of the presently disclosed subject matter, generating the incident reconstruction model can comprise: detecting and aligning features extracted from incident-informative data; transforming the collected incident-informative data into a common dimensional space and time frame; and 3D model reconstruction.

In accordance with other aspects and, optionally, in combination with the above aspects of the presently disclosed subject matter, there are provided methods of incident reconstruction and incident-related behavior reconstruction.

In accordance with other aspects and, optionally, in combination with the above aspects of the presently disclosed subject matter, there are provided one or more computing devices comprising processors and memory, the one or more computing devices configured, via computer-executable instructions, to perform operations for operating, in a cloud computing environment, a system capable of detecting an incident using road-informative data collected by a plurality of source-modalities. The operations comprise: for each given source-modality (SM) from the plurality of source-modalities, processing road-informative data collected by the given SM to obtain one or more feature-level data-modalities associated with the given SM, thereby giving rise to a plurality of obtained data-modalities, wherein each given data-modality is informative of one or more features extracted, during processing, from road-informative data collected by an associated SM; when at least one data-modality from the plurality of data-modalities is indicative of a potential incident, fusing the plurality of data-modalities into one or more machine learning models (MLMs) to confirm detecting an incident; responsive to the confirmation of the incident detection, providing one or more incident-related actions.

In accordance with other aspects of the presently disclosed subject matter, there is provided a system capable of detecting an incident using road-informative data collected by a plurality of source-modalities, the system comprising a computer configured to perform the operations disclosed above. Optionally, at least part of the operations can be provided in a cloud environment.

In accordance with other aspects of the presently disclosed subject matter, there is provided a non-transitory computer-readable medium comprising instructions that, when executed by a computing system comprising a memory storing a plurality of program components executable by the computing system, cause the computing system to operate in accordance with the methods above.

### BRIEF DESCRIPTION OF THE DRAWINGS

In order to understand the presently disclosed subject matter and to see how it can be carried out in practice, embodiments will be described, by way of non-limiting examples, with reference to the accompanying drawings, in which:

FIG. 1 illustrates a generalized block diagram of an Incident Detection and Reconstruction System (IDRS) in accordance with certain embodiments of the presently disclosed subject matter;

FIG. 2 illustrates a generalized flow-chart of operating the IDRS in accordance with certain embodiments of the presently disclosed subject matter;

FIGS. 3a and 3b illustrate generalized flow-charts of non-limiting examples of fusing feature-level data-modalities into one or more machine learning models in accordance with certain embodiments of the presently disclosed subject matter;

FIGS. 4 and 5 illustrate schematic diagrams of non-limiting examples of fusing feature-level data-modalities into one or more machine learning models in accordance with certain embodiments of the presently disclosed subject matter;

FIG. 6 illustrates a generalized flow-chart of incident reconstruction in accordance with certain embodiments of the presently disclosed subject matter;

FIG. 7 illustrates a generalized block diagram of Incident Reconstruction Module in accordance with certain embodiments of the presently disclosed subject matter; and

FIG. 8 illustrates a generalized flow-chart of creating 3D behavioral reconstruction model in accordance with certain embodiments of the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing terms such as “processing”, “computing”, “representing”, “fusing”, “applying”, “assessing”, “extracting” or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, Incident Detection and Reconstruction System and processing and memory (PMC) circuitry(s) therein disclosed in the present application.

The operations in accordance with the teachings herein may be performed by a computer specially constructed for the desired purposes or by a general-purpose computer specially configured for the desired purpose by a computer program stored in a non-transitory computer-readable storage medium.

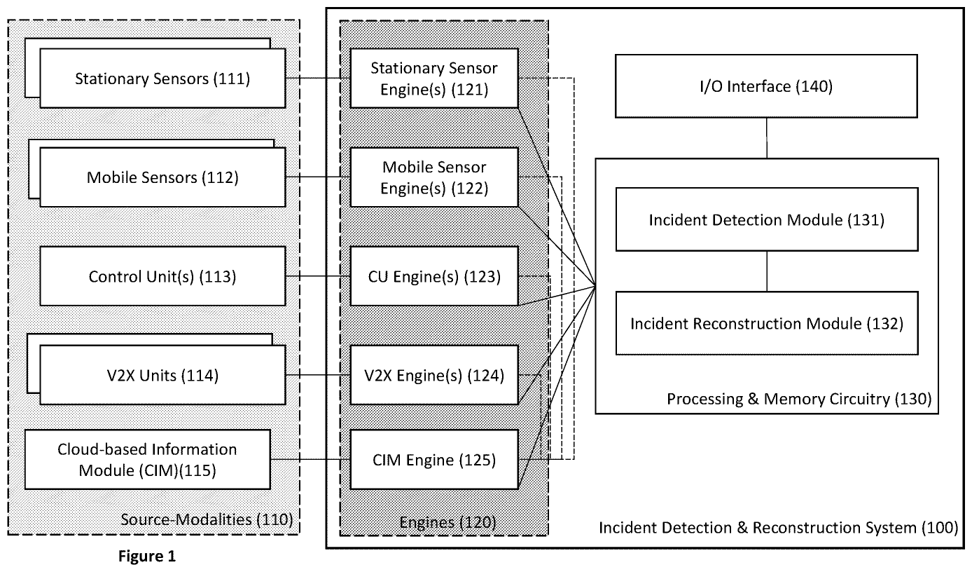

Bearing this in mind, attention is drawn to FIG. 1 illustrating a block diagram of an Incident Detection and Reconstruction System (IDRS) in accordance with certain embodiments of the presently disclosed subject matter. IDRS 100 is operatively connected to a plurality of source-modalities 111-115 (collectively referred to as source-modalities 110), each source-modality configured to collect road-informative data.

Unless specifically stated otherwise, throughout the specification the term “road-informative data” refers to any data, metadata and derivatives thereof informative of road users, a road (including roadways, intersections, road structures, sidewalks, bike lanes, etc.) and traffic therein. Road-informative data can be captured from the road by different types of sensors in different bandwidths.

The term “road user” refers to any entity using the road, for example, pedestrians, cyclists, motorcycles, private cars, trucks, buses, emergency vehicles, etc.

Source-modalities 110 can include stationary sensors 111 (e.g. mounted on elements of road structures) and mobile sensors 112 (e.g. mounted on vehicles, mobile devices or otherwise connected and/or integrated with road users, mounted on unmanned aerial vehicles (UAVs) of different types, etc.). Sensors 111 and 112 can be of different types as, for example, cameras, LIDARs, long-range radars, short-range radars, etc.

At least part of sensors 111 and 112 can include processing and memory circuitry (PMC) configured to provide an initial processing of the captured data to recognize the road users, define at least part of such road users' parameters as location, speed, acceleration, bearing, past and predicted future trajectory and track at least part of the road users. By way of non-limiting example, the sensors 111 and 112 can be configured to track the road users with parameters matching predefined criteria (e.g. overspeed, over-acceleration, dangerous predicted trajectory, etc.).

Source-modalities 110 can further include one or more control units (CUs) 113 operatively connected to road infrastructure (e.g. traffic controllers) and configured to gather therefrom data informative of real-time traffic lights status and duration, configuration information, the timing and sequence of the lights, the presence of any relevant signals or signs (e.g. dynamic message signs, dynamic lane indicators, etc.) and alike. In certain embodiments, at each interception, control unit 113 can be located within a traffic cabinet and can be configured to gather information data from the traffic controller(s) at the intersection. Control units 113 can include processing and memory circuitry (PMC) configured to provide an initial processing of the gathered data.

Further, source-modalities 110 can include V2X (vehicle-to-everything) units 114 receiving vehicle motion-related and/or safety-related data from respective vehicles and/or other suitable entities with the help of V2X messages. Typically, V2X message set includes data informative of ID of respective vehicle, its location, bearing, speed, acceleration, past trajectory and predicted future trajectory. V2X units 114 can include processing and memory circuitry (PMC) configured to provide an initial processing of the received data.

Thus, the term “collected road-informative data” refers to road-informative data captured, gathered, received or otherwise acquired by a given source-modality and/or to derivatives of the acquired data resulted from pre-processing provided by the given source-modality.

At least part of source-modalities 111, 112, 113 and 114 can be configured to record and save locally the road-informative data collected during a predetermined limited time.

In certain embodiments, source-modalities 110 can further include a cloud-based information module (CIM) 115 configured to collect and store behavioral and aggregated data related to the road (e.g. Automated Traffic Signal Performance Measures (ATSPMs) and other statistics, real-time and statistical data from navigation and mapping applications, etc.) and received from one or more external sources. CIM 115 can further collect and store data informative of external factors related to the road and traffic therein (e.g. historical and current weather reports, historical and current traffic reports, data about public events with potential impact on traffic at specific time and location, data about roadworks, geographic information system (GIS) data, etc.).

Furthermore, at least part of data collected by source-modalities 111, 112, 113 and 114 can be transferred to CIM 115 and stored thereon. Optionally, data from source-modalities 111, 112, 113 and/or 114 can be transferred to CIM 115 only responsive to one or more predefined events (including timeout for local storing the respective data).

IDRS 100 comprises a plurality of engines 121-125 (collectively referred to hereinafter as engines 120) operatively connected to a processing and memory circuitry (PMC) 130. PMC 130 is further connected to Input/Output Interface 140.

Engines 120 are configured to provide the operative connection between IDRS 100 and source-modalities 110. Engines 120 are configured to receive (in pull and/or push mode) road-informative data collected by respective source-modalities, and to process the received data to yield data-modalities. Engines 120 are further configured to feed the obtained data-modalities into PMC 130.

Each engine is operatively connected to a respective modality of the plurality of source-modalities 120 and vice versa.

It is noted that one or more sensors (or other sources) connected to the same engine are considered herein as a single source-modality.

By way of non-limiting example, engines 120 can include one or more engines selected from: at least one stationary sensor engine 121 corresponding to at least one stationary sensor source-modality 111; at least one mobile sensor engine 122 corresponding to at least one mobile sensor source-modality 112; at least one CU engine 123 corresponding to at least one CU source-modality 113; at least one V2X engine 124 corresponding to at least one V2X source-modality 114; and at least one CIM engine 125 corresponding to at least one CIM source-modality 125.

Engines 120 are executable software components that perform the functions as described below. In certain embodiments all engines can be configured to be executed by PMC 130. In other embodiments, at least part of engines 120 can be, at least partly, executed by PMC(s) (not shown) of respective source-modalities. Engines 120 can be implemented in any appropriate combination of software with firmware and/or hardware.

PMC 130 comprises a processor and a memory (not shown separately within the PMC) and is operatively connected to engines 120 and I/O interface 140. PMC 130 is configured to execute several program components in accordance with computer-readable instructions implemented on a non-transitory computer-readable storage medium therein. Such executable program components are referred to hereinafter as functional modules comprised in the PMC. The functional modules can be implemented in any appropriate combination of software with firmware and/or hardware.

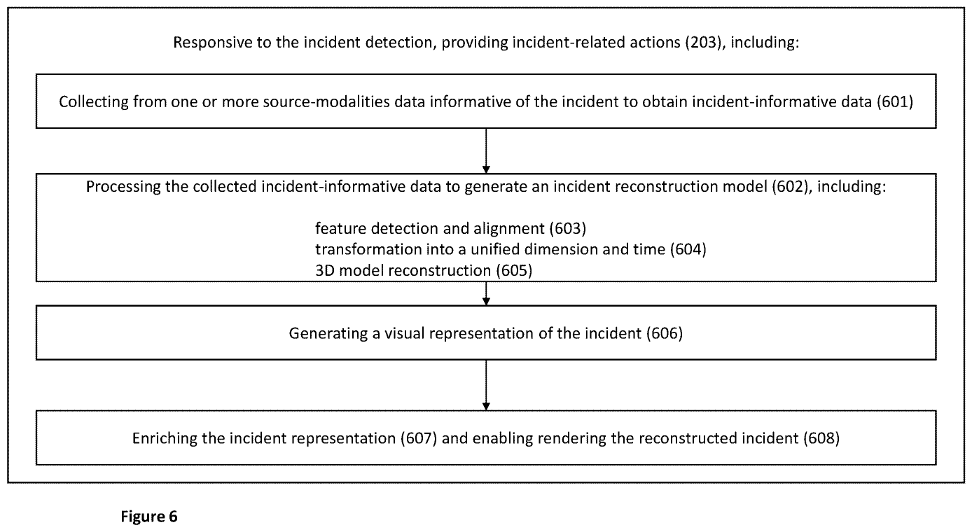

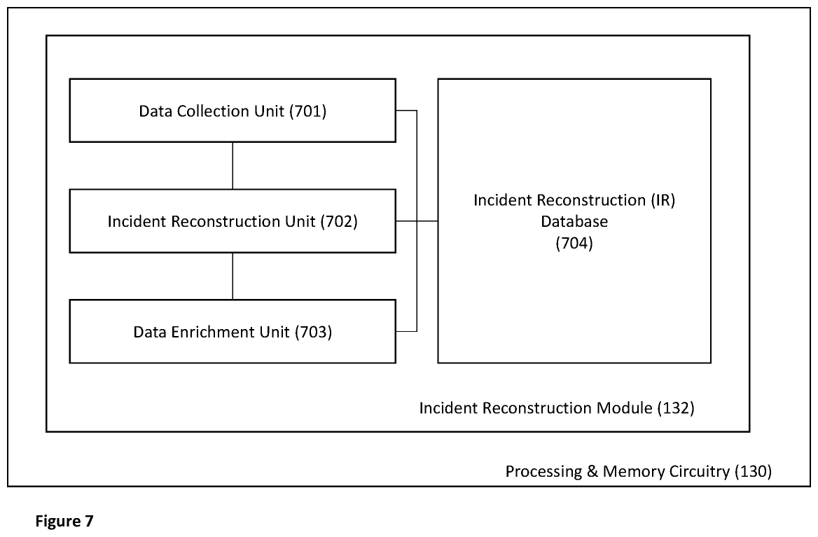

The functional modules in PMC 130 can comprise operatively connected incident detection module 131 and incident reconstruction module 132. Incident detection module 131 is configured to accommodate and apply one or more trained Machine Learning Models usable by IDRS 100 when operating as detailed below. Incident reconstruction module 132 is configured to enable operations further detailed with reference to FIGS. 6 and 7.

I/O interface 140 can be configured to enable interfacing with a web application that allows users to fetch, search, filter, and/or download incident-related data. Alternatively or additionally, I/O interface 140 can be configured to provide an API that can be exposed to external companies and individuals, thereby allowing integration with their own applications. Further, I/O interface 140 can be configured to provide a dedicated API facilitating connection between IDRS 100 and external systems.

It is noted that the teachings of the presently disclosed subject matter are not bound by the Incident Detection and Reconstruction System (IDRS) described with reference to FIG. 1. Equivalent and/or modified functionality can be consolidated or divided in another manner and can be implemented in any appropriate combination of software with firmware and/or hardware and executed on suitable device(s). The source-modalities and/or engines can be consolidated or divided in other manner.

IDRS 100 can be a standalone entity or integrated, fully or partly, with other entities. IDRS 100 can be implemented, at least partly, in a distributed and/or cloud and/or virtualized computing environment. The functional modules (and/or parts thereof) shown in FIG. 1 can be distributed over several local and/or remote computers (including computers located in a cloud environment) and can be linked through a communication network.

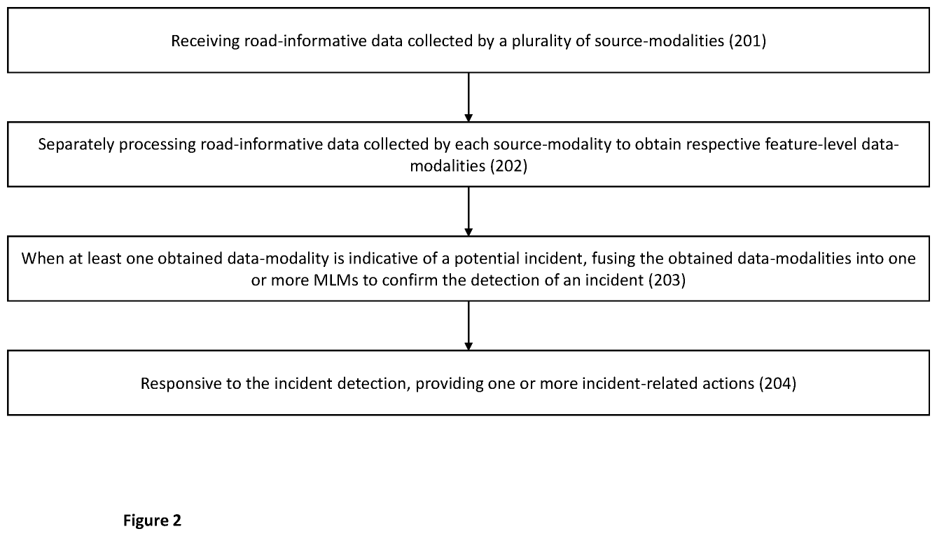

Referring to FIG. 2, there is illustrated a method of operating the Incident Detection and Reconstruction System (IDRS) in accordance with certain embodiments of the presently disclosed subject matter.

IDSR 100 receives (201) road-informative data collected by a plurality of source-modalities. Each engine 121-125 processes road-informative data collected by respective source-modality to obtain (202) one or more feature-level data-modalities.

Engines 120 are configured to use one or more incident detection techniques as detailed below. By way of non-limiting example, engines 120 can use anomaly detection techniques to detect potential incidents based on identifying unusual data patterns that, potentially, may be caused by such incidents.

A data-modality obtained by a given engine is associated with a respective source-modality and is informative of one or more features extracted by the given engine from road-informative data collected by the respective source-modality.

A data-modality obtained by a given engine can be informative of one or more individually extracted features (e.g. trajectory, location, speed and/or acceleration and changes thereof). Alternatively or additionally, an obtained data-modality can be informative of a predefined set of features corresponding to a type of direct and indirect incident effect and to a respective source-modality.

When an incident occurs, it often leads to direct and indirect effects detectable as anomalies in data patterns.

Direct effects can include changes in a vehicle trajectory, abnormal vehicle's location, speed and/or acceleration changes, etc. Short-range indirect effects can include stuck vehicles, people getting and staying out of their vehicles, people gathering, traffic changes and alike. Medium-range indirect effects can lead to changes in traffic statistics including the count of vehicles and delay time. Long-range indirect effects include clearing and recovery time, appearing of emergency vehicles, etc.

In certain embodiments, a given engine can run one or more the incident detection models, for example:
statistical models capable to analyze statistical properties of the data and detect anomalies based on deviations from expected patterns;
machine learning (ML) models including training algorithms on a dataset of normal traffic behavior and using the resulting model to detect anomalies (e.g. a supervised learning algorithm can be trained to classify incidents based on sensor data, or an unsupervised learning algorithm can be used to identify clusters of abnormal behavior;
rule-based models that involve defining a set of rules or thresholds for what constitutes the normal behavior and flagging anything outside of those rules as an anomaly (e.g. a rule-based method could flag any sudden changes in vehicle speed and location as potential incidents).

In certain embodiments, the applied incident detection techniques can differ for different engines 120.

Sensor engines 121 or 122 can detect incidents with the help of a rule-based model with the inputs informative of the scene-for example, 2nd level data informative of whether a vehicle is stuck, whether a pedestrian is in a bad place, whether a queue is forming, etc. Alternatively or additionally, sensor engines 121 or 122 can detect anomalies with the help of ML/Statistical models with the inputs informative of queue length, delay time, vehicles and pedestrians trajectories (location, speed, heading history), etc. Likewise, Long Short-Term Memory (LSTM) networks and/or transformer neural networks can be helpful to analyze temporal sequences of sensor (e.g. radar and/or camera) data to identify patterns that precede incidents, like erratic vehicle movements or sudden decelerations.

CU engine 123 can detect incidents with the help of rule-based model with inputs informative of data available from Traffic Controller (e.g. controller status, phases status, detectors status, service status, etc.) and/or derivatives thereof (e.g. traffic decisions results from a system operating a traffic optimization mode). Alternatively or additionally, CU engine 123 can detect anomalies with the help of ML/Statistical models with inputs informative of detectors status, phase service (time serving), etc.

V2X engine 124 can analyze V2X messages collected from vehicles (e.g., Basic Safety Messages in DSRC or C-V2X protocols) for real-time alerts on hard braking, airbag deployment, or emergency vehicle notifications.

CIM engine 125 can detect anomalies with the help ML/Statistical models with inputs informative of ATSPMS-based statistical data (e.g. total & average vehicle delay, vehicle counts, pedestrians counts, cycle time, etc.).

In certain embodiments, engines 120 can detect a potential incident with the help of vehicle trajectory analysis. By way of non-limiting example, applying clustering algorithms (e.g., K-means, DBSCAN) to vehicle trajectories derived from sensor data is helpful to identify abnormal patterns, such as sudden stops or deviations from normal paths, which may indicate an incident. By way of another non-limiting example, using predictive models to estimate future positions of vehicles can be helpful for detecting deviations between the current and the predicted trajectories.

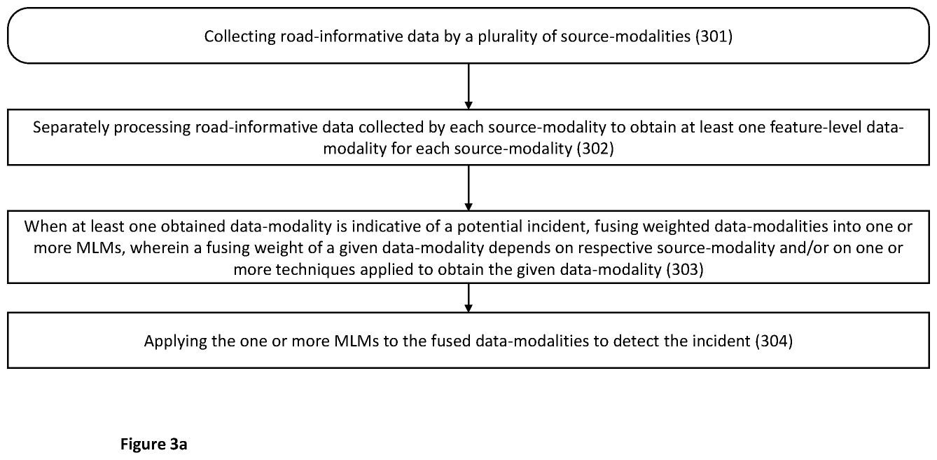

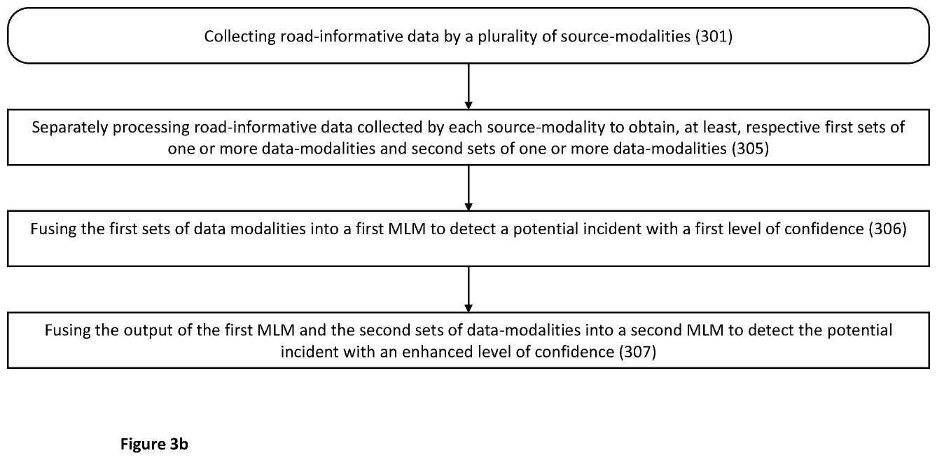

When at least one obtained data-modality is indicative of a potential incident, IDRS 100 fuses the obtained feature-level data-modalities into one or more Machine Learning Model(s) to confirm the detection of incident (203). The incident is considered as confirmed when the confidence level of its detection meets a predefined criterion. FIGS. 3-5 illustrate non-limiting examples of fusion techniques in accordance with certain embodiments of the presently disclosed subject matter.

Responsive to the confirmed incident detection, IDRS 100 provides one or more incident-related actions (204). By way of non-limiting example, the incident-related actions can include incident reconstruction, initiating alerts and/or reports to emergency services, law enforcement offices, police, insurance companies, etc.

Referring to FIGS. 3a and 3b, there are illustrated generalized flow charts of non-limiting examples of fusing the obtained feature-level data-modalities into one or more MLMs.

In the example illustrated in FIG. 3a, upon collecting (301) road-informative data by a plurality of source-modalities, IDRS 100 separately processes road-informative data collected by each source-modality to obtain (302) at least one feature-level data-modality for each source-modality. When at least one of the obtained data-modalities is indicative of a potential incident, IDRS 100 fuses (303) the obtained data-modalities into a MLM, whilst assigning weights thereof prior to the fusion. The fusing weight of a given data-modality can depend on respective source-modality and/or on one or more techniques applied to obtain the given data-modality. Upon fusing, IDRS 100 applies the MLM(s) to the fused data-modalities to detect (304) the incident.

In the example illustrated in FIG. 3b, upon collecting (301) road-informative data by a plurality of source-modalities, IDRS 100 separately processes road-informative data collected by each source-modality to obtain (305), at least, respective first sets of one or more data-modalities and second sets of one or more data-modalities. IDRS 100 fuses the first sets of data-modalities into a first MLM to detect (306) a potential incident with a first level of confidence and further fuses the output of the first MLM and the second sets of data-modalities into a second MLM to detect (307) the potential incident with an enhanced level of confidence.

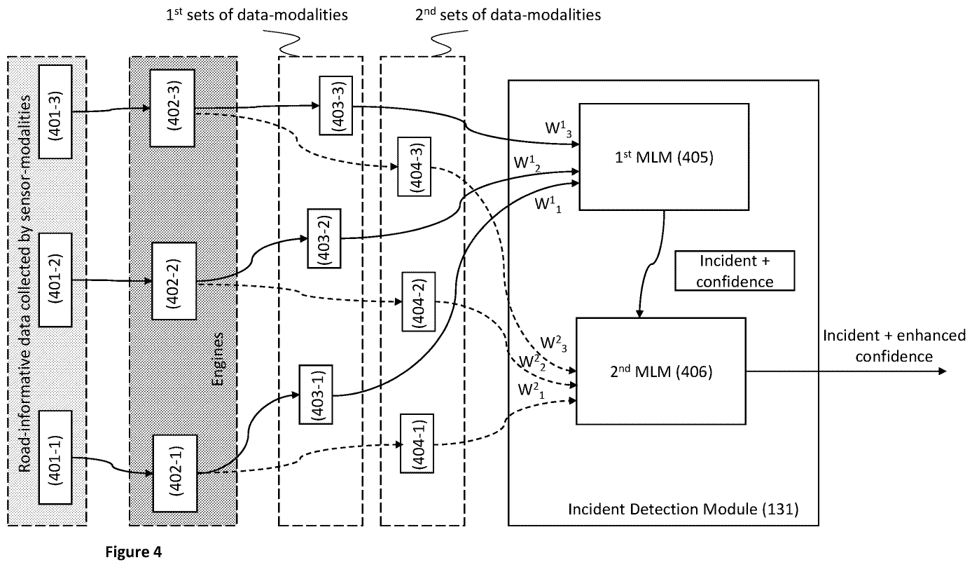

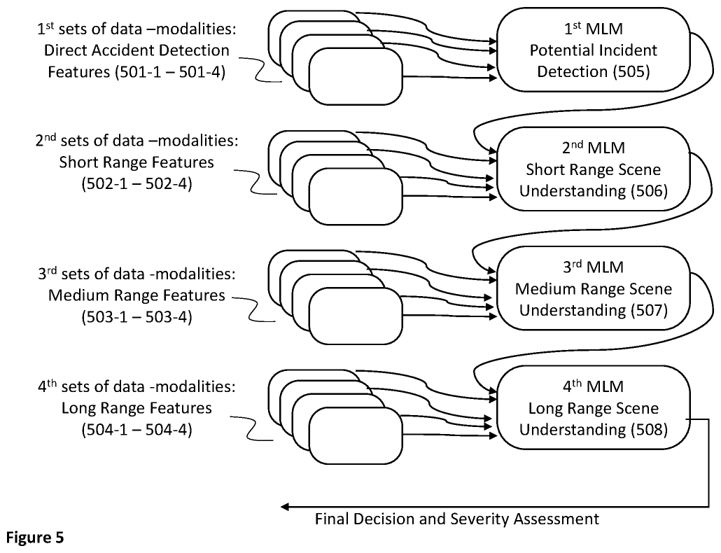

The above examples of fusion techniques are further detailed in FIGS. 4 and 5.

As illustrated in FIG. 4, road-informative data is collected by source-modalities 401-1, 401-2 and 401-3. Engines 402-1, 402-2 and 402-3 process data collected by corresponding source-modalities to obtain, for each given source-modality, a first data-modality and a second data-modality associated therewith, thereby giving rise to a 1^{st} set of first data-modalities and a 2^{nd} set of second data-modalities. As illustrated, the 1^{st} set comprises first data-modalities 403-1, 403-2 and 403-3 associated, respectively, with source-modalities 401-1, 401-2 and 401-3 and the 2^{nd} set comprises second data-modalities 404-1, 404-2 and 404-3 associated, respectively, with the same source-modalities.

Data-modalities 403-1, 403-2 and 403-3 from the 1^{st} set are fused into a first MLM 405 to detect a potential incident with a first level of confidence. Further, the output of MLM 405 and data-modalities 404-1, 404-2 and 404-3 from the 2^{nd} set are fused into a second MLM 406 to detect the potential incident with an enhanced level of confidence (and/or to take the final decision with regard to the incident detection).

As illustrated, the first data-modalities 403-1, 403-2 and 403-3 are fused in MLM 405 with respective weighs W¹₁, W¹₂ and W¹₃, at least one of the weights being different from the others. Likewise, the second data-modalities 404-1, 404-2 and 404-3 are fused in MLM 406 with respective weighs W²₁, W²₂ and W²₃, at least one of the weights being different from the others. Optionally, output of MLM 405 can also be weighted prior to fusing into MLM 406.

In certain embodiments, at least part of data-modalities from the same set can be informative of the same feature. The fusing weight of such modalities can depend on associated source-modalities. By way of non-limiting example, a fusing weight of trajectory-informative data-modality associated with V2X source-modality can be configured higher than a fusing weight of trajectory-informative data-modality associated with sensor source-modality. Likewise, a fusing weight of trajectory-informative data-modality associated with camera-based sensor source-modality can be set higher than a fusing weight of trajectory-informative data-modality associated with a radar-base sensor source-modality when road visibility is good, and the opposite configuration can be applied when road visibility is poor.

Alternatively or additionally, in certain embodiments at least part of data-modalities from the same set can be informative of the different features. The fusing weights of such data-modalities can depend on the respective features. By way of non-limiting example, a fusing weight of data-modality informative of abnormal vehicle location can be configured higher than a fusing weight of trajectory-informative data-modality.

In certain embodiments, at least part of source-modalities can be associated with more than 2 sets of data-modalities obtained therefrom. In certain embodiments, data-modalities from set_{N} can be fused into MLM_{N+1} together with output of MLM_{N} so that, finally, to detect the incident with a required confidence level. In certain embodiments, the outputs of MLMs can be weighted before fusion. By way of non-limited example, the fusing weights of said outputs can increase for each next MLM.

It is noted that different source-modalities can be associated with different number of sets of data-modalities obtained therefrom. Likewise, data-modalities obtained from a certain source-modality can belong to different plurality of sets than data-modalities obtained from another source-modality. Thus, source-modalities associated with data-modalities fused in MLM_{I} can, at least partly, differ from source-modalities associated with data-modalities fused in MLM_{K}.

It is further noted that the teachings of the presently disclosed subject matter are not bound by the configuration of MLMs sequence described above. MLMs can be organized in chain(s), tree(s) or any other suitable configuration.

A non-limiting example of a chain of four MLMs is illustrated in FIG. 5. First data-modalities (501-1-501-4) in the first set are informative of a predefined set of features corresponding to direct incident effects, second data-modalities (502-1-502-4) in the 2^{nd} set are informative of a predefined set of features corresponding to a short-range indirect incident effects, third data-modalities (503-1-503-4) in the 3^{rd} set are informative of a predefined set of features corresponding to a medium-range indirect incident effects, and fourth data-modalities (504-1-504-4) in the 4^{th} set are informative of a predefined set of features corresponding to a long-range indirect incident effects.

First data-modalities (501-1-501-4) are fused in 1^{st} MLM (505). Its output is informative of detection of a potential incident and is fused into 2^{nd} MLM 506 together with second data-modalities (502-1-502-4). The output of MLM 506 is based on short-range scene understanding and is fused into 3^{rd} MLM 507 together with third data-modalities (503-1-503-4). The output of MLM 507 is based on medium-range scene understanding and is fused into 4^{th} MLM 508 together with fourth data-modalities (504-1-504-4). The output of MLM 508 is based on long-range scene understanding and is usable for final decision with regard to the incident detection and, optionally, for severity assessment of the incident.

Referring to FIG. 6, there is illustrated a generalized flow chart of incident reconstruction in accordance with certain embodiments of the presently disclosed subject matter. Responsive to the incident detection, IDRS 100 collects (601) from one or more source-modalities data informative of the incident to obtain incident-informative data, uses the collected incident-informative data and derivatives thereof to generate (602) an incident reconstruction model. IDRS 100 further generates (606) a visual representation of the incident, enriches (607) the incident representation, and enables rendering (608) the reconstructed incident.

The corresponding functional units of incident reconstructions module 132 are illustrated in FIG. 7. As illustrated, incident reconstructions module 132 comprises data collection unit 701 operatively connected to incident reconstruction unit 702 further operatively connected to data enrichment unit 703. All units are operatively connected to incident reconstruction database 704 configured to store incident-related data and derivatives thereof as well as incidents representations.

Data collecting 601 comprises gathering incident-related data from relevant source-modalities and processing at least part of the collected data to derive inputs necessary for incident reconstruction.

Responsive to incident detection, incident reconstructions module 132 requests engines 121-125 to collect respective road-informative data from source-modalities 120. The retrieved road-informative data corresponds to a particular timeframe around the point-in-time when the incident is believed to have occurred.

Engines 121-125 receive the requested data and process at least part thereof to derive inputs necessary for incident reconstruction. The inputs and the processing algorithms are specified for each of the engines and depend on source-modalities corresponding thereto. Such collected road-informative data and provided derivatives thereof constitute incident-related data and can be saved in database 704.

In certain embodiments, all road-informative data to be retrieved can be received from source-modalities that collected the respective data. In other embodiments, at a time of request, at least part of the road-informative data collected by source-modalities 111-114 can be transferred for storing in CIM 115 and need to be retrieved therefrom. In such a case, engines 121-124 can receive the required data by requesting engine 125.

By way of non-limiting example, incident-related data can include video feeds, traffic light status and duration data, radar data, V2X data, third-party data, etc. combined with the respective metadata. The incident-related data further comprise trajectory (location, velocity and acceleration) and other relevant data of all road users. Such data can be received from the source-modalities or can be derived by engines 121-124 as requested by incident reconstructions module 132. The incident-related data correspond to a first time period occurring prior to the incident, and to a second predetermined time period occurring after the traffic event. The durations of the periods can differ depending on type of data and severity of the incident.

For example, when an accident is detected, synchronized video feeds can include
10 min high-resolution videos including 2 minutes before the accident, the time of the accident, and 6 minutes after the accident;
100 minutes of low-resolution videos, at a rate of 1 FPS, including 30 minutes before the accident, 10 min−the time of the accident, and 60 minutes after the accident.

Traffic light information provides timestamped status of traffic lights and signs that is necessary for providing a context for the incident. This context includes information on the status and duration of the traffic lights, the timing and sequence of the lights, and the presence of any relevant signals or signs. Further to data about the state of the intersection at the time of a given incident, the information can also include data on traffic flow and patterns before and after the given incident.

Radar data can be informative of vehicles speed and positions. V2X data communicated from vehicles and infrastructure can provide insights into vehicle behavior and actions before the incident. Third party data can include indirect data about the behavior of the intersection (e.g. statistics related to queues that are built, delay time, and other data related to conditions at the intersection leading up to the incident).

Processing the collected incident-informative data to generate (602) the incident reconstruction model, includes: feature detection and alignment (603), transformation into a unified dimension and time (604) and 3D model reconstruction (605).

By way of non-limiting example, feature detection can include using computer vision and machine learning algorithms to detect key features in the video feeds (e.g. involved vehicles, pedestrians, and other notable objects). Radar and V2X data can be further used for validating these features.

Feature detection can further include identifying critical timestamps that mark significant events in the incident sequence (e.g., a sudden brake, collision impact). These timestamps are useful for further aligning data across the sources.

Data alignment includes aligning data from different source-modalities (and/or different data-modalities from the same source) based on the detected features and timestamps. This involves creating a common frame of reference, such as aligning radar detections with video frames with V2X “frames” from all source-modalities together based on the position and movement of vehicles and time.

Transformation (604) of the aligned data into a unified dimension and time allows creating one source of truth. All data-modalities are appropriately normalized and scaled to fit into a unified dimensional model.

The unified dimensional model is further used for 3D model reconstruction (605) of the incident scene. The model reflects the real-world positions, movements, and interactions of all involved road users, thereby providing a layer of reality.

The generated 3D model enables a step-by-step visualization of the incident. This visualization can be used for analysis, investigation, and reconstruction purposes. Incident dynamics can be analyzed with the help of Simulation and Analysis Tools enabling understanding causative factors.

Creating (606) the reconstruction video can involve analyzing the incident data to identify the relevant causes of the incident. The identification can be achieved by comparing the incident parameters to a database of similar incidents (e.g. IR database 704), in order to identify commonalities and potential causes of the incident. The relevant parameters can include incident type, such as red-light runner, sudden stop, or pedestrian involved, background information such as weather or dangerous intersection, participants type such as truck and car, car and car, or chain incident, and severity.

The relevant causes of an incident can be identified using machine learning models to analyze the incident data in IR database and compare it to the new incident data (inputs). This process is designed to identify commonalities and potential causes of the incident, providing a more comprehensive view of the situation. The machine learning models used for this purpose can include clustering models, such as k-means or hierarchical clustering, or anomaly detection models, such as autoencoders or one-class SVMs. By analyzing the incident data and identifying patterns and relationships within it, the models generate output that highlights the relevant causes of the incident (a score to each parameter based on its significance and relevance to the incident output). As detailed above, the causes can include the incident type, background information and participant types. The output is then used to create a video that emphasizes this information visually, helping viewers gain a better understanding of what happened and why.

The generated 3D model enables generating (606) an animated video that accurately represents an incident while being visually engaging and easy to understand. The method involves using a machine learning model that maps incident-related data, including intersection geometrical information, trajectory data, traffic light status, time of day, and incident cause, to the input of the graphic engine language. This can be achieved using deep learning models, such as Convolutional Neural Networks (CNNs), Recurrent Neural Networks (RNNs), or Generative Adversarial Networks (GANs).

The output of the model is a set of parameters that are used as inputs for the graphic engine, including the size and color of the relevant information that is emphasized in the animation. The graphic engine takes these parameters and translates them into a visual representation.

To train the model, a deep learning approach can be used, involving a neural network that can learn from the data. The model is trained on a dataset of incidents and their corresponding animations, with the goal of learning the patterns and relationships between the data and the animation. The training process can be manual, where experts label and annotate the relevant information in the dataset, or it can be automated, where the model is trained on a large dataset of incidents and their corresponding animations using unsupervised learning techniques.

Using a model that maps all the relevant data to the input of the graphic engine language enables automation of the process and creating animations for multiple incidents. Further, the model can be continuously improved by retraining it on new data.

The reconstructed incident is added to the IR database with all the necessary fields, including the location, time, and the outputs from the reconstruction process. The user can view the reconstructed incident and all relevant information via the web App.

In certain embodiments, faces and license plates in the reconstructed video can be blurred. This can be done using computer vision models that detect and blur the faces and license plates, while emphasizing the vehicle types and participants involved, slowing down the footage at the moment of the incident, and highlighting key features such as weather conditions and other relevant data. This can be accomplished using, for example, object detection models, such as YOLO, RCNN, or SSD, and image segmentation models, such as U-Net, Mask R-CNN, or DeepLab. Once the faces and license plates are detected, a blurring filter can be applied to the respective regions to obscure identifying information.

In certain embodiments, the visual representation of the incident can be generated as a schematic animated video. The video can provide a custom-built overview of the incident and the surrounding area, remove noise and clutter from the intersection. Such video helps as well to contextualize the incident, provide a clear view of the events that took place, and preserve the privacy of those involved.

In certain embodiments the animated reconstruction video can be generated by further processing the RHR video. Alternatively, in other embodiments, the animated reconstruction video can be automatically generated by combining all of the collected incident-related data into a single, cohesive visualization.

Generating the visual representation of the incident can be followed by data enrichment (607) thereof. The data enrichment goes beyond basic incident reconstruction by providing a deeper level of analysis and a more comprehensive understanding of the conditions that led to the incident. The enriched data provides a wealth of information that can be used to classify and filter incidents based on various criteria, such as the type of incident, vehicle types involved, or even the time it took for traffic to return to normal. The enriched data can be critical for stakeholders such as insurance companies and transportation planners, as it provides valuable insights into the underlying factors that contribute to incidents.

Data enrichment can be provided as a cloud-based service. The data enrichment service includes additional data like weather conditions, intersection geometrical information, size and crowding, and intersection behavior, like how dangerous, and previous incidents info. This information helps identify whether an intersection is dangerous and prone to incidents. Included information can be the type of incident, for example red light crossing or left turn, the severity of the incident, the arrival and departure times of emergency vehicles, and the time it took for the traffic to return to normal as well as the types of the vehicles that were included in the incident. The data enrichment service also includes Automatic License Plate Recognition (ALPR) data, which can help identify vehicles that were involved in the incident and determine who was at fault.

A respective instance of IR database can include a variety of fields that provide users with valuable insights into incidents and their causes. The fields of IR database instance can include:
Meta data: Time, location, and weather data: This information helps users understand the environmental conditions and other factors that may have contributed to the incident.
Intersection data: size, crowding, info on previous incidents, danger score.
Collision data: this can include information about the severity of the incident, whether anyone was injured or killed, and the types of vehicles and other participants involved in the incident. Additionally, the DB includes information about the type of incident, such as red light running or surprising stops.
Indirect information: this can include details about emergency responders and how long it took for them to arrive at the scene, as well as the impact on traffic and how long it took for traffic to return to normal.
Evidence: this field can include the raw files of videos, metadata, and traffic light status (TLS), as well as the reconstructed video and animated video.

Thus, the users can be enabled to filter and classify the incidents based on their needs. They can add incidents to their favorites or mark them for further work and write both private and public comments to share with other users. The application also allows users to relate incidents to specific cases or incidents, providing a comprehensive view of the impact of incidents on the community.

In addition, IDRS 100 can include an API that can be exposed to external companies and individuals. This allows integration of the data in IR database 704 with other systems and the automation of various processes.

Further to the above, IDRS 100 can be integrated with vehicle telematics systems to facilitate data collection from vehicles involved in incidents, supporting comprehensive analysis and informed decision-making. This integration enables the identification of involved parties for tailored solutions across various sectors, profiling of participants based on their driving data, and the formulation of customized service offerings.

Modern vehicles are increasingly equipped with telematics devices that monitor a range of metrics, including driver behavior and vehicle performance. This rich source of data is invaluable not only for personalizing services but also for enhancing operational efficiency, safety protocols, and customer engagement in sectors such as automotive sales, vehicle rental services, fleet management, and smart city initiatives.

The process of using telematics systems to identify vehicles involved in incidents involves a critical step known as “pairing,” which matches the vehicle across the telematics and IDRS. This is often achieved by correlating GPS data from both sources. Techniques for effective pairing include:
Nearest Neighbor Algorithm: Finds the closest match by calculating the distance between GPS coordinates.
Dynamic Time Warping Algorithm: Aligns time series data from both systems to find the best match, especially useful when data are not synchronized.
Kalman Filter Algorithm: Filters out noise from GPS data and estimates vehicle locations using a predictive mathematical model.
Bayesian Network Algorithm: Uses probabilistic models to estimate the likelihood of matches between GPS coordinates.

Additional parameters such as vehicle type and physical characteristics (e.g., color) can enhance the pairing process. In cases where initial pairing is challenging, further data such as vehicle trajectory patterns or hybrid models incorporating machine learning can improve accuracy.

Engagement with involved parties can be proactive, where the VAR system utilizes available telematics and incident data to identify and respond to events, or passive, where data matching is used to investigate suspected incidents post-factum. Techniques for data matching and profiling include the use of classification and clustering models, which can inform tailored service offerings and operational improvements.

In accordance with certain embodiments of the currently presented subject matter, the machine learning models used for profiling can analyze the accident parameters, driver behavior, and other relevant data to provide personalized pricing recommendations. For example, clustering models can group the customers based on their driving behavior, while decision trees can identify the most important parameters that influence the pricing recommendations. IDRS 100 can further provide feature engineering enabling revealing one or more new features to be taken into consideration. By way of non-limiting example, this can be done by decision trees, principal component analysis (PCA), etc.

In certain embodiments, 3D reconstruction models can be useful for behavior analyses. Creating a 3D behavioral model reconstruction can provide behavioral information as, for example, the number of individuals involved in the accident, the cause of the accident, and their actions immediately before, during, and after the event, etc. Further, such model can be useful for generating customized reports informative of fault determination, the impact of behaviors on the accident outcome, potential injuries, etc.

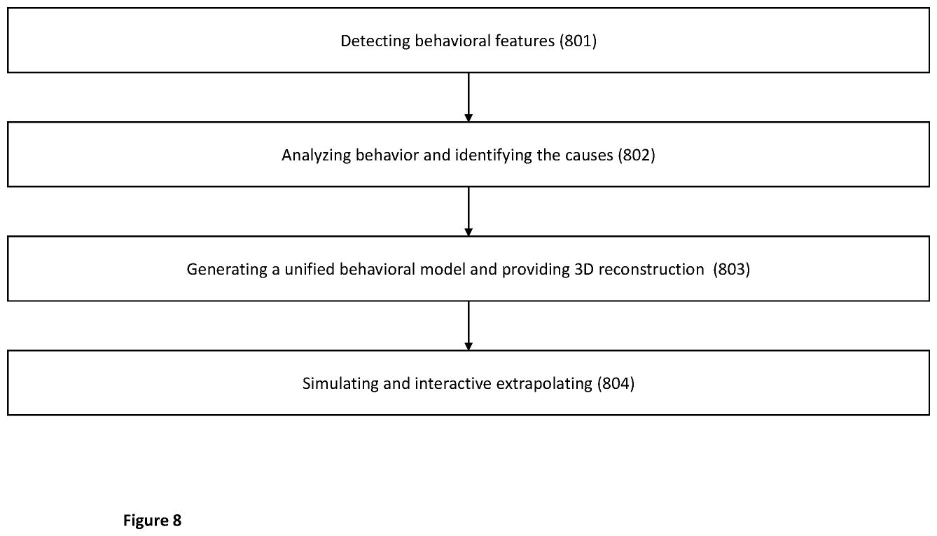

FIG. 8 illustrates a generalized flow-chart of creating a 3D behavior reconstruction model in accordance with certain embodiments of the presently disclosed subject matter.

IDRS 100 uses data informative of the incident and collected from one or more source-modalities to detect (801) behavioral features. IDRS 100 further analyses (802) the respective behavior and provides identification of cause(s). Next, IDRS 100 generates (803) a unified behavioral model and provides 3D reconstruction. 3D reconstruction can be further used for simulating and interactive extrapolating (804) as well as for reporting and analyses.

Behavioral Feature Detection (801) can include:
Person and Object Detection: Use advanced computer vision algorithms to identify and track each individual and vehicle involved in the accident throughout the video footage.
Activity Recognition: Implement machine learning models trained on recognizing specific activities, such as individuals exiting or entering vehicles, to capture key behavioral moments.

The extracted features can be informative of:
Distraction Indicators: Identify behaviors indicative of distraction, such as the use of mobile phones by drivers or pedestrians, looking away from the road, or engaging in activities unrelated to driving;
Aggressive Driving Patterns: Detect signs of aggressive driving before the accident, including speeding, harsh braking, rapid lane changes without signaling, tailgating, and erratic maneuvers;
Seatbelt Usage: Determine whether drivers and passengers were wearing seat belts at the time of the accident, which can influence injury claims and liability assessments;
Pedestrian Behavior: Analyze pedestrian actions, such as jaywalking, ignoring traffic signals, or sudden movements into the path of vehicles, which can contribute to accidents;
Driver Reaction Times: Estimate the reaction time of drivers to sudden obstacles, traffic light changes, or the actions of other road users. This can indicate attentiveness and compliance with safe driving practices;
Vehicle Condition and Maintenance Indicators: Detect visible signs of poor vehicle maintenance that could contribute to an accident, such as worn tires, malfunctioning lights, or damaged brakes;
Weather and Visibility Conditions: Assess the impact of weather conditions (rain, fog, snow) and visibility (nighttime, glare) on the behavior of drivers and pedestrians;
Compliance with Traffic Signals and Signs: Determine whether vehicles and pedestrians complied with traffic lights, stop signs, yield signs, and other traffic controls at the time of the accident;
Post-Accident Behavior: Analyze the actions of individuals immediately after the accident, such as attempts to provide aid, secure the scene, exchange information, or any behaviors that might indicate evasion of responsibility,
Road Rage or Confrontational Behavior: Identify any aggressive or confrontational behavior between individuals before, during, or after the accident, which could be relevant to understanding the context and escalation of the event.

Behavioral Analysis and Cause Identification (802) can include:
Sequence Analysis: Analyze the chronological sequence of detected activities to understand the behavior of individuals before, during, and after the accident.
Cause and Effect Modeling: Use the collected data to model potential causes of the accident. This could involve analyzing vehicle telemetry data for sudden stops or accelerations and correlating it with video evidence of driver distractions or pedestrian actions.

Data Fusion and 3D Reconstruction (803) can be provided in a manner detailed with reference to FIG. 6. Unified Behavioral Model integrates the collected data into a unified model that represents both the physical and behavioral aspects of the accident scene. This involves creating a timeline of events based on the sequence of detected activities and vehicle movements. 3D Scene Reconstruction utilizes 3D modeling software to reconstruct the accident scene, incorporating both the physical environment and the animated behavior of individuals and vehicles. This model is generated to visually represent the timeline of events and highlight key moments identified in the behavioral analysis.

Simulation and Interactive Exploration (804) can include developing an interactive 3D Model allowing different stakeholders to explore different viewpoints, zoom in on specific actions, and replay the accident sequence from various angles. The model can be further annotated with key information, such as timestamps of critical events, speed of vehicles at impact, and points of interest like the initial contact or the final positions of vehicles and individuals.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the presently disclosed subject matter may be, at least partly, implemented on a suitably programmed computer. Likewise, the presently disclosed subject matter contemplates a computer program being readable by a computer for executing the method of the presently disclosed subject matter. The presently disclosed subject matter further contemplates a non-transitory computer-readable memory tangibly embodying a program of instructions executable by the computer for executing the method of the presently disclosed subject matter.

1-19. (canceled)

20. A computerized method of incident detection using road-informative data collected by a plurality of source-modalities, the method comprising:
separately for each given source-modality (SM) from the plurality of source-modalities, processing road-informative data collected by the given SM to obtain a first data-modality and a second data-modality associated with the given SM, thereby giving rise to a first plurality of first data-modalities and a second plurality of second data-modalities, each given data-modality is informative of one or more features extracted, during processing, from road-informative data collected by a respectively associated SM;
wherein each given data-modality in the first plurality is informative of at least one feature of a first predefined set of features corresponding to an associated SM and to one or more direct effects of the incident, and
wherein each given data-modality in the second plurality is informative of at least one feature of a second predefined set of features corresponding to one or more time-depending indirect effects selected from a group comprising short-range indirect effects, medium-range indirect effects and long-range indirect effects;
fusing the first plurality of first data-modalities into a first MLM (Machine Learning Model) to detect a potential incident with a first level of confidence;
further fusing the output of the first MLM and the second plurality of second data-modalities into a second MLM to detect the potential incident with an enhanced level of confidence and considering one or more time-dependent indirect effects; and
when a level of confidence of detecting the potential incident meets a predefined criterion, providing one or more incident-related actions.

21. The method of claim 20, wherein the plurality of SMs comprises a combination of at least one sensor configured to capture road-informative data with at least one of: a control unit configured to gather data from one or more road infrastructure elements, a V2X unit configured to receive vehicle motion-related and/or safety-related data; a cloud-based information module configured to collect behavioral and aggregated data related to the road.

22. The method of claim 20, wherein the obtained data-modalities are fusing into one or more MLMs with assigned fusing weights and wherein a fusing weight of a given data-modality depends on respectively associated SM and/or on one or more techniques applied to obtain the given data-modality.

23. The method of claim 20 further comprising:
for each given SM from at least part of the plurality of SMs, processing road-informative data collected by the given SM to obtain a third data-modality and a forth data-modality associated therewith, thereby giving rise to a third plurality of third data-modalities and a forth plurality of forth data-modalities, wherein the second data-modalities are informative of the second predefined set of features corresponding to one or more short-term indirect incident effects, third data-modalities are informative of a third predefined set of features corresponding to one or more medium-term indirect incident effects and the fourth data-modalities are informative of a forth predefined set of features corresponding to one or more long-range indirect incident effects;
fusing the output of the second MLM and the third plurality of third data-modalities into a third MLM to detect the potential incident with further enhanced level of confidence; and
further fusing the output of the third MLM and the fourth plurality of fourth data-modalities into a fourth MLM to confirm detection of the incident.

24. The method of claim 23, wherein:
the first predefined set of features is informative at least of one of: changes in a vehicle trajectory, abnormal vehicle's location, speed changes and acceleration changes;
the second predefined set of features is informative at least of one of: stuck vehicles, people getting and staying out of their vehicles, people gathering and traffic changes;
the third predefined set of features is informative at least of changes in traffic statistics including the count of vehicles and delay time; and
the forth predefined set of features is informative at least of one of: changes in clearing time, changes in recovery time and appearing of emergency vehicles.

25. The method of claim 20, wherein the outputs of the MLMs are fusing with assigned fusing weights, and wherein fusing weights of the outputs are increasing for each next MLM.

26. The method of claim 20, wherein at least part of data-modalities from the same plurality is informative of the same feature and wherein the fusing weights of such modalities depend on associated SMs.

27. The method of claim 26, wherein the fusing weights of trajectory-informative data-modalities are defined in accordance with at least one of the following rules:
a fusing weight of data-modality associated with V2X SM is higher than a fusing weight of data-modality associated with sensor SM;
a fusing weight of data-modality associated with camera-based sensor SM is higher than a fusing weight of data-modality associated with a radar-based sensor SM when road visibility is good;
a fusing weight of data-modality associated with camera-based sensor SM is lower than a fusing weight of data-modality associated with a radar-based sensor SM when road visibility is poor.

28. The method of claim 20, wherein the incident-related actions include incident reconstruction and wherein the incident reconstruction comprises:
collecting from the plurality of SMs incident-informative data corresponding to a timeframe around the point-in-time when the incident has occurred;
processing the collected incident-informative data to generate the incident reconstruction model;
using the generated incident reconstruction model to generate a visual representation of the incident;
enriching the incident representation; and
enabling rendering the reconstructed incident.

29. The method of claim 28, wherein generating the incident reconstruction model comprises: detecting and aligning features extracted from incident-informative data; transforming the collected incident-informative data into a common dimensional space and time frame; and 3D model reconstruction.

30. One or more computing devices comprising processors and memory, the one or more computing devices configured, via computer-executable instructions, to perform operations for operating, in a cloud computing environment, a system capable of detecting an incident using road-informative data collected by a plurality of source-modalities, the operations comprising:
for each given source-modality (SM) from the plurality of source-modalities, processing road-informative data collected by the given SM to obtain a first data-modality and a second data-modality associated with the given SM, thereby giving rise to a first plurality of first data-modalities and a second plurality of second data-modalities,
wherein each given data-modality in the first plurality is informative of at least one feature of a first predefined set of features corresponding to an associated SM and to one or more direct effects of the incident, and
wherein each given data-modality in the second plurality is informative of at least one feature of a second predefined set of features corresponding to one or more time-depending indirect effects selected from a group comprising short-range indirect effects, medium-range indirect effects and long-range indirect effects;
fusing the first plurality of first data-modalities into a first MLM to detect a potential incident with a first level of confidence;
further fusing the output of the first MLM and the second plurality of second data-modalities into a second MLM to detect the potential incident with an enhanced level of confidence; and
when a level of confidence of detecting the potential incident meets a predefined criterion, providing one or more incident-related actions.

31. A system capable of detecting an incident using road-informative data collected by a plurality of source-modalities, the system comprising a computer configured to perform the operations comprising:
for each given source-modality (SM) from the plurality of source-modalities, processing road-informative data collected by the given SM to obtain a first data-modality and a second data-modality associated with the given SM, thereby giving rise to a first plurality of first data-modalities and a second plurality of second data-modalities,
wherein each given data-modality in the first plurality is informative of at least one feature of a first predefined set of features corresponding to an associated SM and to one or more direct effects of the incident, and
wherein each given data-modality in the second plurality is informative of at least one feature of a second predefined set of features corresponding to one or more time-depending indirect effects selected from a group comprising short-range indirect effects, medium-range indirect effects and long-range indirect effects;
fusing the first plurality of first data-modalities into a first MLM to detect a potential incident with a first level of confidence;
further fusing the output of the first MLM and the second plurality of second data-modalities into a second MLM to detect the potential incident with an enhanced level of confidence; and
when a level of confidence of detecting the potential incident meets a predefined criterion, providing one or more incident-related actions.

32. The system of claim 31, wherein at least part of the operations is provided in a cloud environment.

33. The system of claim 31, wherein the plurality of SMs comprises a combination of at least one sensor configured to capture road-informative data with at least one of: a control unit configured to gather data from one or more road infrastructure elements, a V2X unit configured to receive vehicle motion-related and/or safety-related data; a cloud-based information module configured to collect behavioral and aggregated data related to the road.

34. The system of claim 31, wherein the obtained data-modalities are fusing into one or more MLMs with assigned fusing weights and wherein a fusing weight of a given data-modality depends on respectively associated SM and/or on one or more techniques applied to obtain the given data-modality.

35. The system of claim 31 further comprising:
for each given SM from at least part of the plurality of SMs, processing road-informative data collected by the given SM to obtain a third data-modality and a forth data-modality associated therewith, thereby giving rise to a third plurality of third data-modalities and a forth plurality of forth data-modalities, wherein the second data-modalities are informative of the second predefined set of features corresponding to one or more short-term indirect incident effects, third data-modalities are informative of a third predefined set of features corresponding to one or more medium-term indirect incident effects and the fourth data-modalities are informative of a forth predefined set of features corresponding to one or more long-range indirect incident effects;
fusing the output of the second MLM and the third plurality of third data-modalities into a third MLM to detect the potential incident with further enhanced level of confidence; and
further fusing the output of the third MLM and the fourth plurality of fourth data-modalities into a fourth MLM to confirm detection of the incident.

36. The system of claim 31, wherein the outputs of the MLMs are fusing with assigned fusing weights, and wherein fusing weights of the outputs are increasing for each next MLM.

37. The system of claim 31, wherein at least part of data-modalities from the same plurality is informative of the same feature and wherein the fusing weights of such modalities depend on associated SMs.

38. The system of claim 37, wherein the fusing weights of trajectory-informative data-modalities are defined in accordance with at least one of the following rules:
a fusing weight of data-modality associated with V2X SM is higher than a fusing weight of data-modality associated with sensor SM;
a fusing weight of data-modality associated with camera-based sensor SM is higher than a fusing weight of data-modality associated with a radar-based sensor SM when road visibility is good;
a fusing weight of data-modality associated with camera-based sensor SM is lower than a fusing weight of data-modality associated with a radar-based sensor SM when road visibility is poor.

39. A non-transitory computer-readable medium comprising instructions that, when executed by a computing system comprising a memory storing a plurality of program components executable by the computing system, cause the computing system capable of detecting an incident using road-informative data collected by a plurality of source-modalities, to provide operations comprising:
for each given source-modality (SM) from the plurality of source-modalities, processing road-informative data collected by the given SM to obtain a first data-modality and a second data-modality associated with the given SM, thereby giving rise to a first plurality of first data-modalities and a second plurality of second data-modalities,
wherein each given data-modality in the first plurality is informative of at least one feature of a first predefined set of features corresponding to an associated SM and to one or more direct effects of the incident, and
wherein each given data-modality in the second plurality is informative of at least one feature of a second predefined set of features corresponding to one or more time-depending indirect effects selected from a group comprising short-range indirect effects, medium-range indirect effects and long-range indirect effects;
fusing the first plurality of first data-modalities into a first MLM to detect a potential incident with a first level of confidence;
further fusing the output of the first MLM and the second plurality of second data-modalities into a second MLM to detect the potential incident with an enhanced level of confidence; and
when a level of confidence of detecting the potential incident meets a predefined criterion, providing one or more incident-related actions.
